(19) United States
(12) Patent Application Publication
(10) Pub. No.: US 2022/0071189 A1
(43) Pub. Date: Mar. 10, 2022

(54) SUNSHADE ROD HOLDER MOUNT

(71) Applicant: TACO METALS, LLC, MIAMI, FL (US)

(72) Inventors: PHILIP J. SEROCKI, SPARTA, TN (US); WILLIAM KUSHNER, MIAMI, FL (US)

(21) Appl. No.: 17/466,427

(22) Filed: Sep. 3, 2021

Related U.S. Application Data
(60) Provisional application No. 63/074,692, filed on Sep. 4, 2020.

(51) Int. Cl. A01K 97/10; F16M 13/02

(52) U.S. Cl. CPC A01K 97/10; F16M 13/022

(57) ABSTRACT

A mount assembly that mounts in a rod holder with a rod holding tube that has a cross-pin. The assembly includes a support tube with a base end that has a slot formed therein. The slot is configured to receive the cross-pin therein in a mounted position of the support tube in the rod holder. The base end has support tube threads. A knob has knob threads that mate with the tube threads and threads onto the base end of the support tube to secure the mount assembly to the rod holder.

### CROSS REFERENCE TO RELATED APPLICATIONS

This application claims benefit of U.S. Provisional Patent Application No. 63/074,692 filed Sep. 4, 2020, titled Sunshade Rod Holder Mount, the disclosure of which is incorporated herein by reference in its entirety.

### BACKGROUND OF THE INVENTION

Supports and mounts for a removable sunshade.

### a) Field of the Invention

This invention relates to the field of sport fishing boats with rod holders and other boats with rod holders that have the need for a support for a removable accessory such as as a sunshade, center rigger or outrigger.

### b) Description of the Related Art

It is well known to provide accessories such as a sunshades on a boat. Sunshades are typically provided with frames constructed and fitted for a set location on a vessel, which limits the positioning of the shade. However, none use a rod holder in the manner disclosed in the present invention.

### SUMMARY OF THE INVENTION

It is accordingly an object of the invention to provide an accessory rod holder mount which overcomes the above-mentioned disadvantages of the heretofore-known devices and methods of this general type and which locks into a rod holder using a threaded knob at the bottom of the rod holder mount to secure the mount in place in the rod holder. The mount selectively mounts any accessory that needs to be securely retained in any suitable rod holder in a straight-forward and efficient manner.

With the foregoing and other objects in view there is provided a mount assembly that mounts in a rod holder with a rod holding tube that has a cross-pin. The assembly includes a support tube with a base end that has a slot formed therein. The slot is configured to receive the cross-pin therein in a mounted position of the support tube in the rod holder. The base end has support tube threads. A knob has knob threads that mate with the tube threads and threads onto the base end of the support tube to secure the mount assembly to the rod holder.

It is accordingly a further object of the invention, the base end has a stud with the slots formed therein.

In accordance with an added feature of the invention, the stud is a plug connected to the base end of the support tube.

In accordance with an additional feature of the invention the the knob has a planar face with friction ridges provided as radially extending rays from a center axis of the knob.

In accordance with yet an additional feature of the invention, there is an accessory tube adjustably mounted to the support tube opposite the base end and configured to receive an accessory therein.

In accordance with yet another added feature of the invention, the assembly has a collar disposed to slide on the support tube. The collar is configured for taking up circumferential clearance between the support tube and the rod holding tube.

In accordance with still another added feature of the invention, the collar has a flared end configured to match the rod holding tube.

In accordance with still another added feature of the invention, the slot has a slot base with a radius that matches a diameter of the pin.

Although the invention is illustrated and described herein as embodied in the mount assembly, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### DRAWINGS

FIG. 1 is a perspective view of a mount;

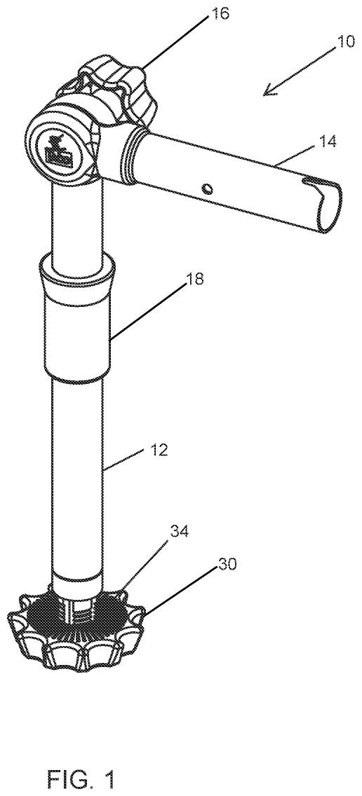

FIG. 2 is a side view of the mount of FIG. 1;

FIG. 3 is a top view of the mount;

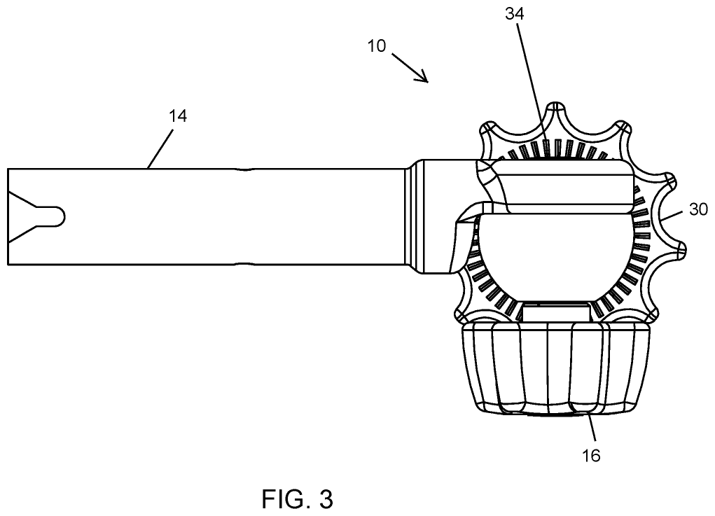

FIG. 4 is a perspective view of the mount shown in a rod holder;

FIG. 5 is a side view of the mount shown in the rod holder;

FIG. 6 is longitudinal section of the mount in the rod holder;

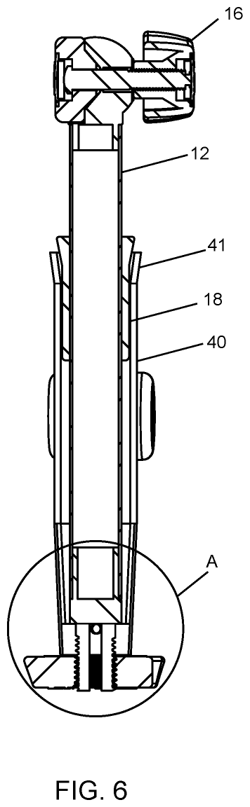

FIG. 7 is an enlarged view the detail ‘A’ in FIG. 6;

FIG. 8 is a base end view of the mount;

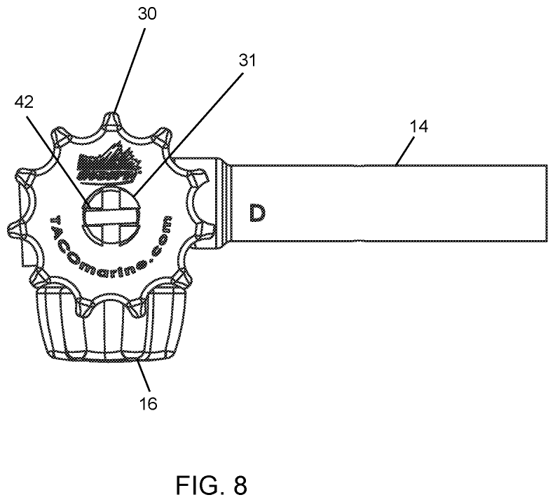

FIG. 9 is an enlarged view of a portion of FIG. 8;

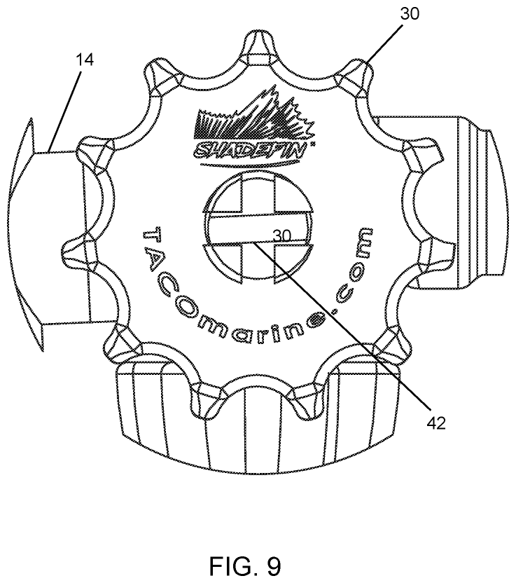

FIG. 10 is an enlarged section view of the mount for another embodiment;

FIG. 11 is a perspective base end view of a support tube for the embodiment of FIG. 10; and

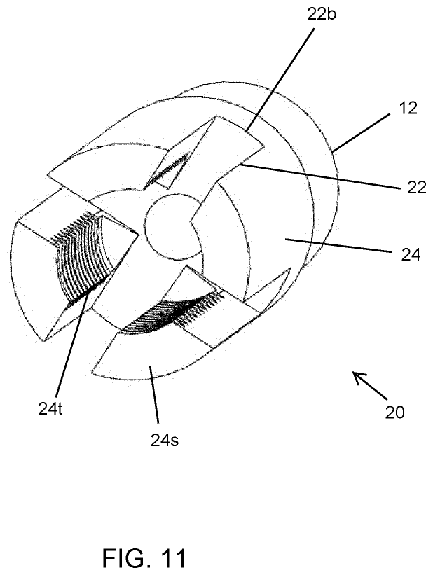

FIG. 12 is a base end view of the support tube for the embodiment of FIG. 10.

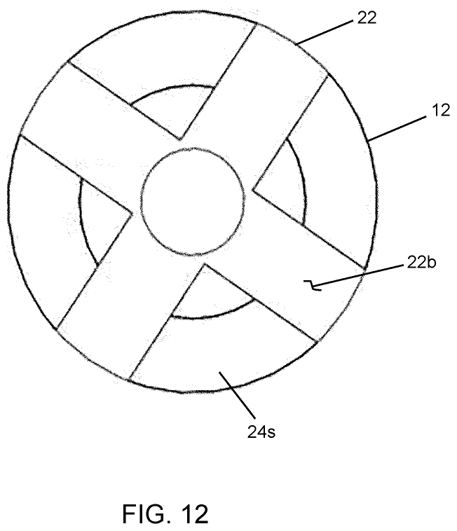

### DESCRIPTION OF THE INVENTIONS

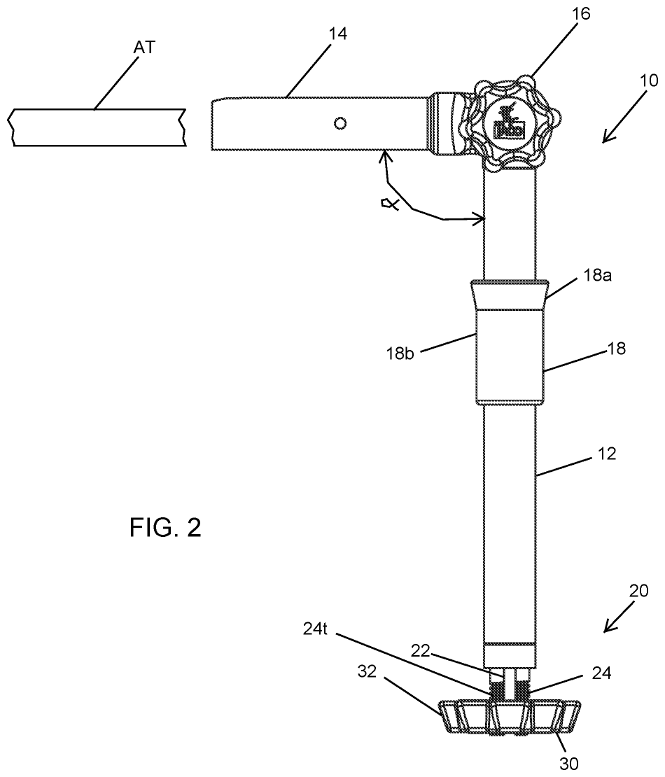

A mount assembly 10 is shown in the figures. The mount assembly 10 mounts to a fishing rod holder 40 with a rod holding tube 41 and serves to accept an accessory such as a sunshade, center rigger or outrigger. The rod holder mount 10 has a support tube 12 and a holder tube 14. The holder tube 14 is constructed to accept an accessory tube AT, such as is partially shown in FIG. 2. The holder Lube 14 includes an aperture for engagement with a spring-loaded locking button on the accessory tube AT, as is known in the art, to releasably lock the accessory tube AT in the holder tube 14. A lockable connector 16 pivotably connects support tube 12 and holder tube 14 with respect to one another and locks the tubes 12 and 14 at an adjustable user selected angle α with respect to one another. This provides for the user to set the accessory in a desired angular position.

Support tube 12 has a preferred diameter of 1¼ n inches, but can be any diameter that corresponds to a rod holder or other tubular holder. Support tube 12 has a removable collar 18 that slides onto the support tube 12. The collar 18 is of a rigid plastic material. The collar 18 is slideably mounted on support tube 12 and has a flared portion 18a and a cylindrical portion 18b. Flared portion 18a tapers from a wider diameter to the diameter of the cylindrical portion 18b. The cylindrical portion 18b has a diameter that is less than the inside diameter rod holding tube 41 of the rod holder 40. The diameter of the flared portion 18a increases from the diameter of the cylindrical portion 18b to a diameter greater than the inside diameter of rod holder 40. The flared end 18a engages the insertion end of the rod holder 40. The collar 18 takes up circumferential clearance between the support tube 12 and the rod holder 40 in order to prevent unwanted rattling or vibration of the mount 10 due to wind, rocking, or when the boat is in motion.

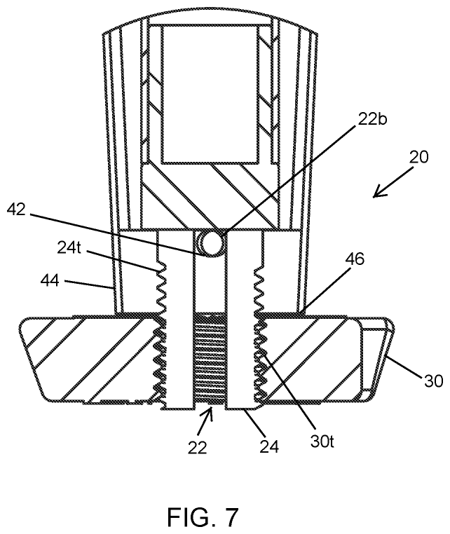

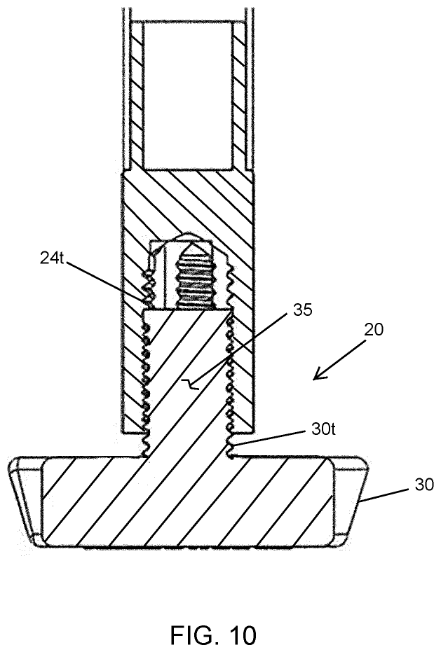

A base end 20 of the support tube 12 is constructed with a stud 24 having threads 24t. The threads 24t can be male or female as respectively shown in the FIGS. 7 and 10. The stud 24 may be provided as a plug that is fastened to the inside diameter of the support tube 12 at the base end 20 thereof. The threaded stud 24 is provided with longitudinally extending slot (s) 22, which receive a pin or cross pin 42 of the rod holder 40 that is provided at the base of the rod holder 40. If one pin 42 is provided in the rod holder 40, then at least one slot 22 is provided and defines two half stud segments 24s and if cross pins are provided in the rod holder 40, then two slots 22 are provided, which due to the intersection of the slots defines a central void and thus four slots 22 in a wall defining the stud 24. In this instance, the slots 22 segments the stud 24 into 4 quarter stud segments 24s. Each of the stud segments 24s are provided with arc portions of the threads 24t of the stud 24 associated with the arc surface of the respective stud segment 24s. The slots 22 allow the stud 24 and stud threads 24t to be disposed below the pin (s) 42 so that a knob 30 with the appropriate mating male/female threads 30t can be threaded onto the stud 24/stud segments 24s. This construction provides for knob 30 to be threaded onto the support tube 12 to securely fasten the support tube 12 to the rod holder 40 by having the pin(s) 42 rest against the bases 22b of the slots 22. In use, the collar 18 is positioned so that the stud 24 extends beyond the pin(s) 42 and the knob 30 is threaded onto the stud 24. The knob 30 is tightened until the pin(s) 42 are secure against the base(s)s 22b of the slots 22.

The threaded knob 30, is preferably molded and made of nylon, though it can be made of any material, and has a general circular shaped grip portion 32. Threaded knob 30 has friction ridges 34 on a planar side 36 facing the support tube 12 that engage against a base end 48 of the rod holder 40. The friction ridges 34 are defined by radially extending rays that extend from a center axis of knob 30 and serve to prevent unintended loosening of the knob 30 due to vibrations of the boat.

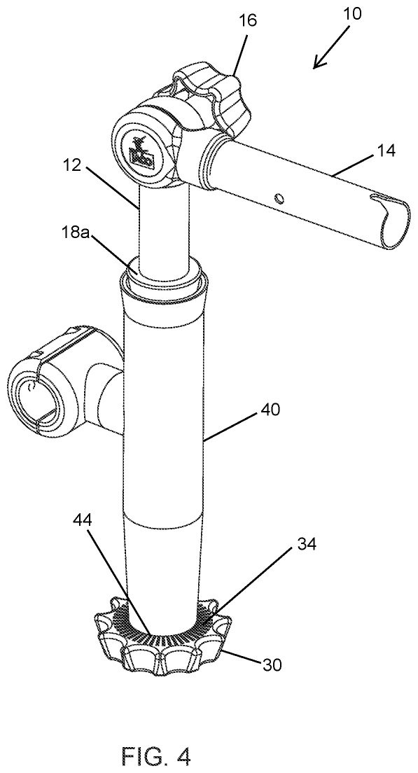

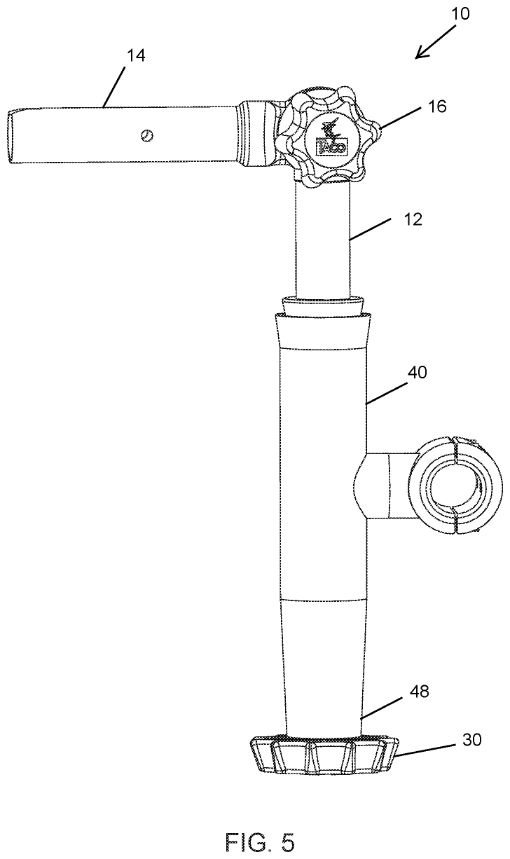

In use, as shown in FIGS. 4 and 5, support tube 12 of rod mount assembly 10 is inserted into the rod holder 40. The pin(s) 42 at a distal end 48 of rod holder 40 are received in the slot(s) 22. The distal end of rod holder 40 generally has a circular end 44 with a smooth edge 46. The rod holder 40 typically has an inside diameter of about 1⅝ inches.

The length of support tube 12 is greater than the length of rod holder tube 41. When the support tube 12 is inserted into the rod holder tube 41, the pin(s) 42 enter the slot 22 and the base of the slot(s) 22b will contact the pin(s) 42 and the threaded stud 24 will extend beyond the pin(s) 42 at the distal end 20 of support tube 12.

Knob 30 has mating threads 30a, in an aperture 31 (female) or on an outside diameter of a projection 35 (male), to the threads 24t for tightening onto stud 24 so that the friction ridges 34 contact the smooth edge 46 of circular end 44 of rod holder 40. As the knob 30 is hand tightened, the friction ridges 34 will releasably come in contact with smooth edge 46 for a tight friction fit to securely hold mount assembly 10 within rod holder 40 by holding the pin(s) against the base of the slot(s) 22b.

I claim:

1. A mount assembly for mounting in a rod holder having a rod holding tube with a cross-pin, the assembly comprising:
a support tube having a base end, said base end having a slot formed therein, said slot being configured for receiving the cross-pin therein in a mounted position of the support tube in the rod holder, said base end having support tube threads; and
a knob having knob threads for mating with said tube threads and threading onto said base end of said support tube for securing the mount assembly to the rod holder.

2. The mount assembly according to claim 1, wherein said base end has a stud with said slots formed therein.

3. The mount assembly according to claim 2, wherein said stud is a plug connected to said base end of said support tube.

4. The mount assembly according to claim 1, wherein said knob has a planar face with friction ridges provided as radially extending rays from a center axis of said knob.

5. The mount assembly according to claim 1, further comprising an accessory tube adjustably mounted to said support tube opposite said base end and configured for receiving an accessory therein.

6. The mount assembly according to claim 1, further comprising a collar disposed to slide on said support tube, said collar being configured for taking up circumferential clearance between said support tube and the rod holding tube.

7. The mount assembly according to claim 6, wherein said collar has a flared end configured to match the rod holding tube.

8. The mount assembly according to claim 1, wherein said slot has a slot base with a radius that matches a diameter of the pin.
